(19) United States
(12) Patent Application Publication
(10) Pub. No.: US 2024/0019770 A1
(43) Pub. Date: Jan. 18, 2024

(54) MOTORIZED TRIPOD AND LIGHT ASSEMBLY

(71) Applicant: Racquel Thompson, San Diego, CA (US)

(72) Inventor: Racquel Thompson, San Diego, CA (US)

(21) Appl. No.: 17/864,069

(22) Filed: Jul. 13, 2022

(51) Int. Cl. G03B 15/07; H04B 7/26; G03B 17/56; F16M 11/28; F16M 11/18; F16M 11/08; F16M 11/04

(52) U.S. Cl. CPC G03B 15/07; H04B 7/26; G03B 17/561; F16M 11/28; F16M 11/18; F16M 11/08; F16M 11/041; F16M 2200/068; F16M 2200/08

(57) ABSTRACT

A motorized tripod and light assembly for adjusting the height and length of the tripod includes a tripod. An arm assembly is positioned upon the tripod and further includes a base. An extender is positioned within the interior of the base and protrudes out from the interior of the base to adjust a height of the arm assembly. A lower arm has a distal end and a proximal end relative to the extender, and the proximal end of the lower arm is coupled to the extender by a motor. Furthermore, an upper arm has a distal end and a proximal end relative to the lower arm, and the proximal end of the upper arm is coupled to the distal end of the lower arm by a motor. A mount is coupled to the distal end of the upper arm by a motor. Additionally, the mount has a ring light.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to tripod device and more particularly pertains to a new tripod device for adjusting the height and length of the tripod.

### (2) Description of Related Art Including Information Disclosed Under 37 CFR 1.97 and 1.98

The prior art relates to tripod devices. The prior art relates to a variety of tripod devices configured to support a mobile device for photography purposes. Furthermore, the prior art relates to a variety of tripod devices having a light source. Known prior art lacks a tripod device having a light source being configured for supporting a mobile device with a motorized arm for adjustment of the height and length of the tripod.

### BRIEF SUMMARY OF THE INVENTION

An embodiment of the disclosure meets the needs presented above by generally comprising a tripod having a plurality of legs. Each of the legs has a foot and a joint. The joint of each of the legs is coupled to a plate. An arm assembly is positioned upon the tripod and further includes a base. The base is positioned upon the plate of the tripod and protrudes upward therefrom. The base has an interior, and the interior of the base houses a microprocessor. Additionally, the microprocessor has a Bluetooth transceiver. An extender is positioned within the interior of the base and is configured for protruding out from and into the interior of the base wherein adjusting a height of the arm assembly relative to the tripod. A lower arm has a distal end and a proximal end relative to the extender and the proximal end of the lower arm is coupled to the extender by a motor. Furthermore, an upper arm has a distal end and a proximal end relative to the lower arm, and the proximal end of the upper arm is coupled to the distal end of the lower arm by a motor. A mount is coupled to the distal end of the upper arm by a motor. The mount has a clamp configured for holding a second mobile device. Lastly, the mount has a ring light.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a motorized tripod and light assembly according to an embodiment of the disclosure.

FIG. 2 is a top view of an embodiment of the disclosure.

FIG. 3 is a top in-use view of an embodiment of the disclosure.

FIG. 4 is a top in-use view of an embodiment of the disclosure.

### DETAILED DESCRIPTION OF THE INVENTION

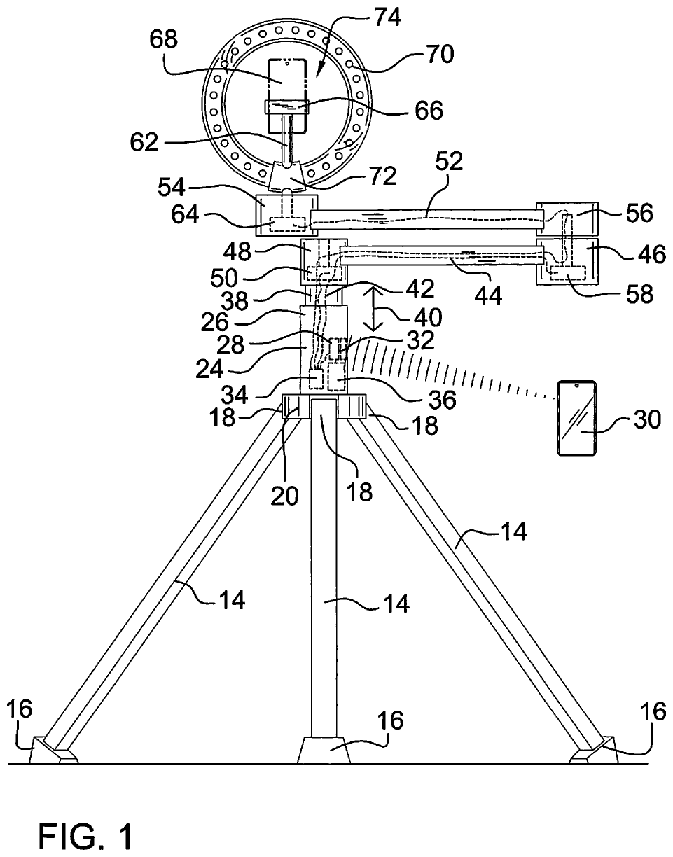

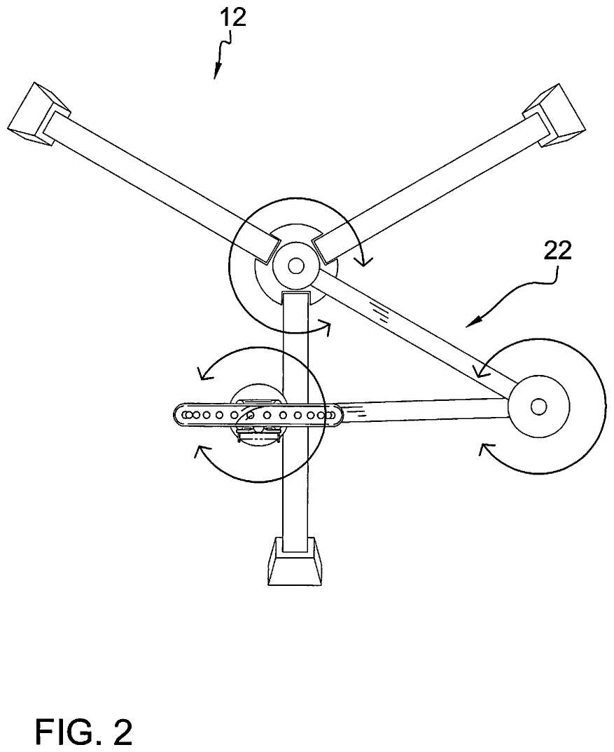

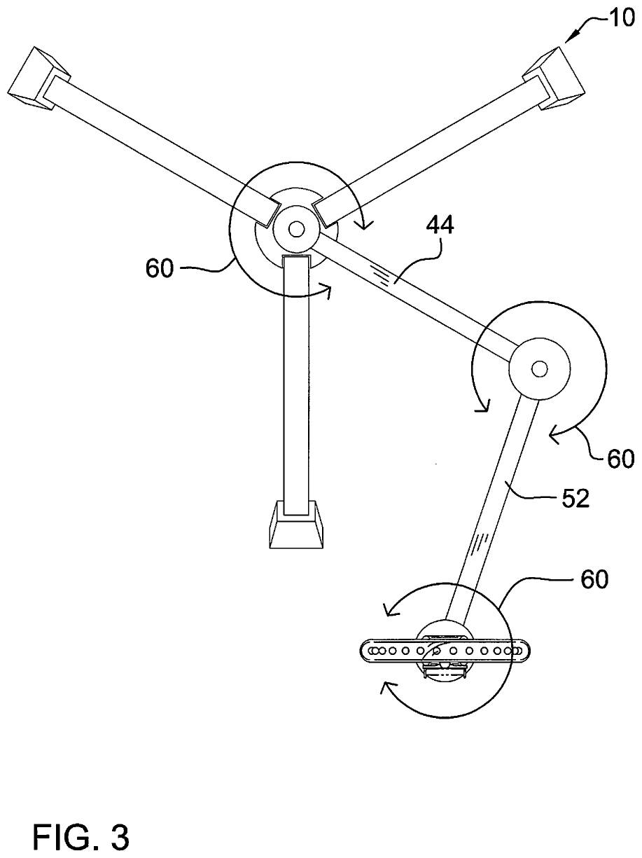

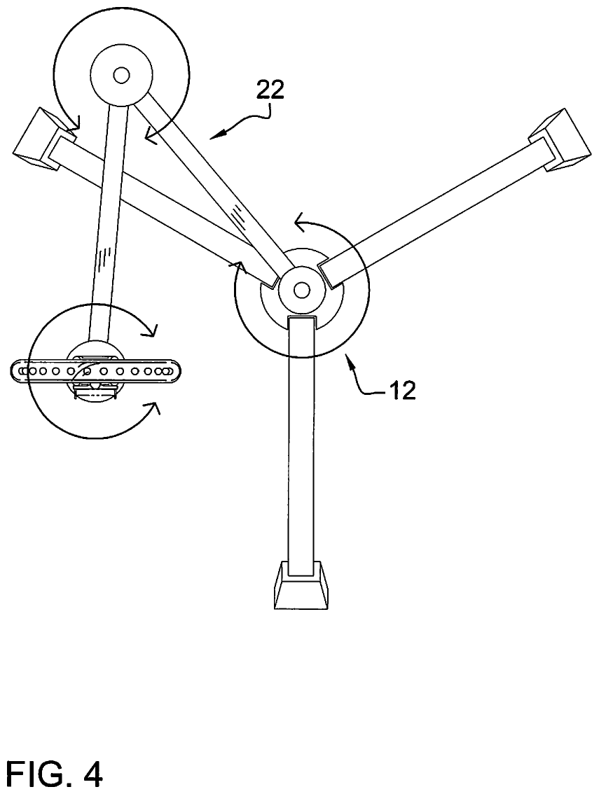

With reference now to the drawings, and in particular to FIGS. 1 through 4 thereof, a new tripod device embodying the principles and concepts of an embodiment of the disclosure and generally designated by the reference numeral 10 will be described.

As best illustrated in FIGS. 1 through 4, the motorized tripod and light assembly generally comprises a tripod 12. The tripod 12 has a plurality of legs 14, and each of the legs 14 has a foot 16 and a joint 18. The foot 16 of each of the legs 14 has a rubber base configured for providing support to the tripod 12. The joint 18 of each of the legs 14 is coupled to a junction 20. The plate 20 is a junction configured for securing each of the legs 14 in a circular arrangement around the plate 20. The circular arrangement provides equal weight distribution between each of the legs 14 wherein retaining the tripod 12 from tipping over.

An arm assembly 22 is positioned upon the tripod 12. The arm assembly 22 is configured for being a motorized robotic arm. The arm assembly 22 further includes a base 24 positioned upon the plate 20 of the tripod 12 and protrudes upward therefrom. The base 24 has an interior 26 defining a space for a variety of elements to be positioned within. The interior 26 of the base 24 houses a microprocessor 28. The microprocessor 28 is configured for rendering information from a first mobile device 30. The first mobile device 30 is in wireless communication with Bluetooth transceiver 32 of the microprocessor 28.

In addition, the interior 26 of the base 24 houses a motor controller 34. The motor controller 34 is in electric communication with the microprocessor 28 and is configured for actuating a variety of motors within the arm assembly 22. Furthermore, a battery 36 is positioned within the interior 26 of the base 24 and is in electric communication with the microprocessor 28. The battery 36 provides electric power to the microprocessor 28, thus to the elements of the arm assembly 22 as well.

An extender 38 is positioned within the interior 26 of the base 24. The extender 38 is configured for protruding out from and back into the interior 26 of the base 24 wherein adjusting a height 40 of the arm assembly 22 relative to the tripod 12. The extender 38 has a motor 42 being in electric communication with the motor controller 34, wherein the motor 42 adjusts the height 40 of the arm assembly 22 by actuation from the motor controller 34. Additionally, a lower arm 44 has a distal end 46 and a proximal end 48 relative to the extender 38. The proximal end 48 of the lower arm 44 is coupled to the extender 38 by a motor 50. The motor 50 of the lower arm 44 is configured for rotating the lower arm 44 relative to the base 24.

Furthermore, an upper arm 52 has a distal end 54 and a proximal end 56 relative to the lower arm 44. The proximal end 56 of the upper arm 52 is coupled to the distal end 46 of the lower arm 44 by a motor 58. The motor 58 of the upper arm 52 is configured for rotating the upper arm 52 relative to the lower arm 44. The upper arm 52 and lower arm 44 are configured to create a z-arm movement 60 wherein the arm assembly 22 is able to move in a one hundred and eighty degree motion and able to extend outward six meters relative to the tripod 12.

A mount 62 is coupled to the distal end 54 of the upper arm 52 by a motor 64. The motor 64 of the mount 62 is configured for rotating the mount 62 relative to the upper arm 52. The mount 62 has a clamp 66 configured for holding a second mobile device 68. The second mobile device 68 is configured for taking photos or videos. Additionally, the mount 62 has a ring light 70. An end 72 of the ring light 70 is coupled to the mount 62 wherein the clamp 66 is positioned in a center 74 of the ring light 70. The ring light 70 is configured for being positioned perpendicular to the surface the tripod 12 is standing upon, wherein the ring light 70 is positioned facing the user. The ring light 70 has a plurality of light emitting diodes being in electric communication with the microprocessor 28.

In use, the second mobile device 68 is fastened to the mount 62 by the clamp 66. The user can connect the first mobile device 30 to the Bluetooth transceiver 32 to input commands for the microprocessor 28 to render. The user can turn the ring light 70 on or off using the first mobile device 30. Additionally, the user can raise the height 40 of the arm assembly 22 relative to the tripod 12 using the first mobile device 30. The user can extend out the arm assembly 22 relative to the tripod 12 using command inputs from the first mobile device 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mechanized tripod and light assembly configured to adjust the positioning of a camera by a mobile device controller, the mechanized tripod and light assembly comprising:
a tripod having a plurality of legs, each of said legs having a foot and a joint, said joint of each of said legs being coupled to a plate;
an arm assembly being positioned upon said tripod, said arm assembly further including:
a base being positioned upon said plate of said tripod and protruding upward therefrom, said base having an interior, said interior of said base housing a microprocessor, said microprocessor having a Bluetooth transceiver;
an extender being positioned within said interior of said base, said extender being configured for protruding out from and into said interior of said base wherein adjusting a height of said arm assembly relative to said tripod;
a lower arm having a distal end and a proximal end relative to said extender, said proximal end of said lower arm being coupled to said extender by a motor; and
an upper arm having a distal end and a proximal end relative to said lower arm, said proximal end of said upper arm being coupled to said distal end of said lower arm by a motor; and
a mount being coupled to said distal end of said upper arm by a motor, said mount having a clamp, said clamp being configured for holding a second mobile device, said mount having a ring light.

2. The mechanized tripod and light assembly of claim 1, further comprising said foot of each of said legs having a rubber base, said rubber base of said foot of each of said legs being configured for providing support to said tripod.

3. The mechanized tripod and light assembly of claim 1, further comprising said plate being a junction configured for securing each of said legs in a circular arrangement around said plate.

4. The mechanized tripod and light assembly of claim 1, further comprising said arm assembly being configured for being a motorized robotic arm.

5. The mechanized tripod and light assembly of claim 1, further comprising said interior of said base defining a space for a variety of elements to be positioned within.

6. The mechanized tripod and light assembly of claim 1, further comprising said microprocessor being configured for rendering information from a first mobile device.

7. The mechanized tripod and light assembly of claim 6, further comprising said Bluetooth transceiver being configured for being in wireless communication with said first mobile device.

8. The mechanized tripod and light assembly of claim 7, further comprising said interior of said base housing a motor controller being in electric communication with said microprocessor, said motor controller being configured for actuating a variety of motors within said arm assembly.

9. The mechanized tripod and light assembly of claim 8, further comprising a battery being positioned within said interior of said base, said battery being in electric communication with said microprocessor.

10. The mechanized tripod and light assembly of claim 1, further comprising said extender being configured for protruding out from and into said interior of said base wherein adjusting a height of said arm assembly relative to said tripod.

11. The mechanized tripod and light assembly of claim 10, further comprising said extender having a motor, said motor of said extender being in electric communication with said motor controller.

12. The mechanized tripod and light assembly of claim 1, further comprising said motor of said lower arm being configured for rotating said lower arm relative to said base.

13. The mechanized tripod and light assembly of claim 1, further comprising said motor of said upper arm being configured for rotating said upper arm relative to said lower arm.

14. The mechanized tripod and light assembly of claim 1, further comprising said motor of said mount being configured for rotating said mount relative to said upper arm.

15. The mechanized tripod and light assembly of claim 1, further comprising an end of said ring light being coupled to said mount wherein said clamp being positioned in a center of said ring light, said ring light having a plurality of light emitting diodes, each of said light emitting diodes being in electric communication with said microprocessor.

16. A mechanized tripod and light assembly configured to adjust the positioning of a camera by a mobile device controller, the mechanized tripod and light assembly comprising:
a tripod having a plurality of legs, each of said legs having a foot and a joint, said foot of each of said legs having a rubber base, said rubber base of said foot of each of said legs being configured for providing support to said tripod, said joint of each of said legs being coupled to a plate, said plate being a junction configured for securing each of said legs in a circular arrangement around said plate;
an arm assembly being positioned upon said tripod, said arm assembly being configured for being a motorized robotic arm, said arm assembly further including:
a base being positioned upon said plate of said tripod and protruding upward therefrom, said base having an interior, said interior of said base defining a space for a variety of elements to be positioned within, said interior of said base housing a microprocessor, said microprocessor being configured for rendering information from a first mobile device, said microprocessor having a Bluetooth transceiver, said Bluetooth transceiver being configured for being in wireless communication with said first mobile device, said interior of said base housing a motor controller being in electric communication with said microprocessor, said motor controller being configured for actuating a variety of motors within said arm assembly, a battery being positioned within said interior of said base, said battery being in electric communication with said microprocessor;
an extender being positioned within said interior of said base, said extender being configured for protruding out from and into said interior of said base wherein adjusting a height of said arm assembly relative to said tripod, said extender having a motor, said motor of said extender being in electric communication with said motor controller;
a lower arm having a distal end and a proximal end relative to said extender, said proximal end of said lower arm being coupled to said extender by a motor, said motor of said lower arm being configured for rotating said lower arm relative to said base; and
an upper arm having a distal end and a proximal end relative to said lower arm, said proximal end of said upper arm being coupled to said distal end of said lower arm by a motor, said motor of said upper arm being configured for rotating said upper arm relative to said lower arm; and
a mount being coupled to said distal end of said upper arm by a motor, said motor of said mount being configured for rotating said mount relative to said upper arm, said mount having a clamp, said clamp being configured for holding a second mobile device, said mount having a ring light, an end of said ring light being coupled to said mount wherein said clamp being positioned in a center of said ring light, said ring light having a plurality of light emitting diodes, each of said light emitting diodes being in electric communication with said microprocessor.
